(19) United States
(12) Patent Application Publication
(10) Pub. No.: US 2025/0182474 A1
(43) Pub. Date: Jun. 5, 2025

(54) EAR NUMBER PREDICTION DEVICE

(71) Applicant: NTT DOCOMO, INC., Tokyo (JP)

(72) Inventors: Ryosuke MIZUNO, Chiyoda-ku (JP); Takuya KITADE, Chiyoda-ku (JP); Kazuhiko KANEKO, Yamaguchi City (JP); Motoharu MURATA, Yamaguchi City (JP)

(73) Assignee: NTT DOCOMO, INC., Tokyo (JP)

(21) Appl. No.: 18/844,209

(22) PCT Filed: Mar. 10, 2023
(86) PCT No.: PCT/JP2023/009337

§ 371 Date: Nov. 1, 2024

(30) Foreign Application Priority Data
Mar. 15, 2022 (JP) 2022-039961

(51) Int. Cl. G06V 20/10; G06T 7/11

(52) U.S. Cl. CPC G06V 20/188; G06T 7/11; G06T 2207/30188; G06T 2207/30242

(57) ABSTRACT

A spike number prediction device (10) includes: a counting unit (11) configured to count the number of wheat spikes from image data reflected inside a frame F provided in a cultivation field (wheat cultivation field (30)) of grain using an image recognition technique; and a prediction unit (12) configured to predict, based on a relative size relationship (for example, an area ratio) between a predetermined target range (for example, the entire wheat cultivation field (30))) in the wheat cultivation field (30) and the frame F, and a spike number count value obtained by counting, the number of wheat spikes in the target range.

### TECHNICAL FIELD

The present disclosure relates to a spike number prediction device that predicts the number of spikes of grain. The term “grain” means agricultural crops whose seeds are generally consumed by humans, and examples of the grain include wheat, rice, millet, and barley. The term “spike of grain” means a cluster of flowers or fruits at the end of a stalk of grain, and in counting the number of spikes of grain, a cluster of flowers or fruits at the end of a stalk of grain is counted as one.

### BACKGROUND ART

In wheat cultivation, topdressing to provide necessary nutrients in addition according to the growth of wheat is essential, and to appropriately determine the amount of topdressing, it is necessary to ascertain the number of wheat spikes. By the way, a significant amount of effort is required for actually counting the number of wheat spikes manually. For this reason, it is considered to predict the number of wheat spikes from image data in which a wheat cultivation field is reflected, using an image recognition technique. Such circumstances also exist in predicting the number of spikes of grain other than the number of wheat spikes, and Patent literature 1 discloses a technique for predicting the number of spikes of rice from image data using an image recognition technique.

### CITATION LIST

### Patent Literature

[Patent Literature 1] Japanese Unexamined Patent Publication No. 2011-167163

### SUMMARY OF INVENTION

### Technical Problem

However, in predicting the number of spikes of the grain from image data using the image recognition technique as in Patent Literature 1, it is necessary to manually set such that a target range where grain to be counted is growing matches an imaging range by the camera. For example, it is necessary to strictly adjust a distance X cm between the camera and the cultivation field and an angle of view of the camera with respect to a target range of lateral S cm and longitudinal R cm as illustrated in FIG. 5, and a processing load of time or labor required for such adjustment operation is increased.

The present disclosure has been accomplished to solve the above-described problem, and an object of the present disclosure is to reduce a processing load as described above in spike number prediction processing.

### Solution to Problem

A spike number prediction device according to the present disclosure includes a counting unit configured to count the number of spikes of grain from image data of the grain reflected inside a frame-shaped body provided in a cultivation field of the grain using an image recognition technique, and a prediction unit configured to predict, based on a relative size relationship between a predetermined target range in the cultivation field and the frame-shaped body, and a spike number count value obtained by counting in the counting unit, the number of spikes of the grain in the target range.

In the above-described spike number prediction device, the counting unit counts the number of spikes of the grain from the image data of the grain reflected inside the frame-shaped body provided in the cultivation field of the grain using the image recognition technique. The “frame-shaped body” herein is a real object, not a virtual object, and a shape of the frame-shaped body is not limited to a specific shape as long as a relative size relationship (for example, an area ratio) between the frame-shaped body and the target range is known. The image recognition technique that is used in counting the number of spikes of the grain from the image data of the grain reflected inside the frame-shaped body is not limited to a specific technique. In the present disclosure, the use of the frame-shaped body provided in the cultivation field of the grain is one of features, and effects described below are obtained.

Then, the prediction unit predicts the number of spikes of the grain in the target range based on the relative size relationship between the predetermined target range in the cultivation field and the frame-shaped body, and the spike number count value obtained by counting in the counting unit. For example, the prediction unit uses an area ratio (an area of the target range/an area of the frame-shaped body) as an example of the above-described relative size relationship to predict the number of spikes of the grain in the target range by multiplying the number of spikes of the grain in the frame-shaped body obtained by counting and the above-described area ratio (the area of the target range/the area of the frame-shaped body). With this, it is not necessary to strictly adjust a distance between the camera and the cultivation field and an angle of view of the camera with respect to the target range manually such that the target range and an imaging range by the camera match each other. For this reason, it is possible to reduce a processing load of time or labor required for such adjustment operation.

### Advantageous Effects of Invention

According to the present disclosure, it is possible to reduce a processing load as described above in spike number prediction processing.

### BRIEF DESCRIPTION OF DRAWINGS

FIG. 1 is a functional block configuration diagram in an embodiment of the invention.

FIG. 2 is a flowchart illustrating a process that is executed by a spike number prediction device.

FIG. 3 is a diagram illustrating an example where a frame is provided in a wheat cultivation field.

FIG. 4 is a hardware configuration example of the spike number prediction device.

FIG. 5 is a diagram illustrating a problem in the related art.

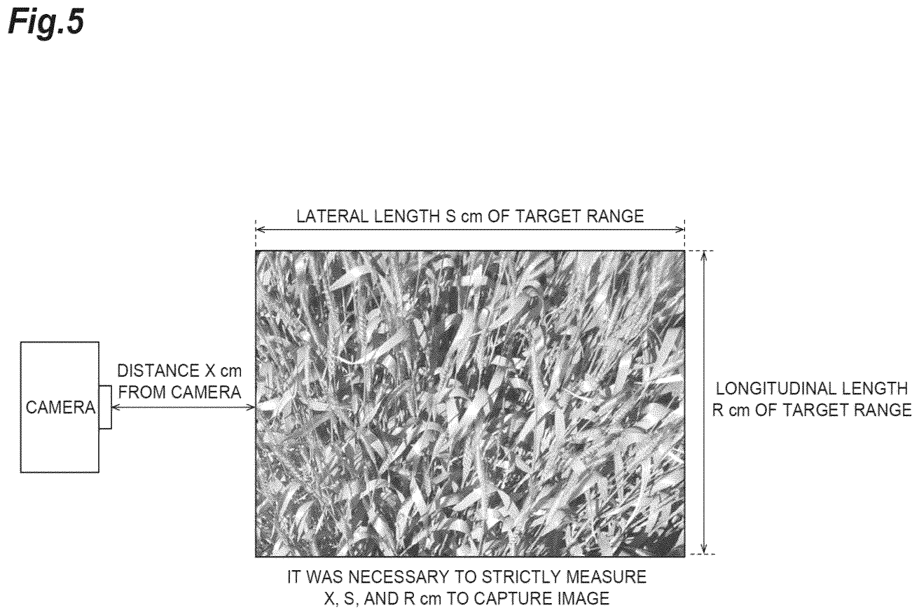

### DESCRIPTION OF EMBODIMENTS

Hereinafter, an embodiment of a spike number prediction device according to the present disclosure will be described with reference to the drawings.

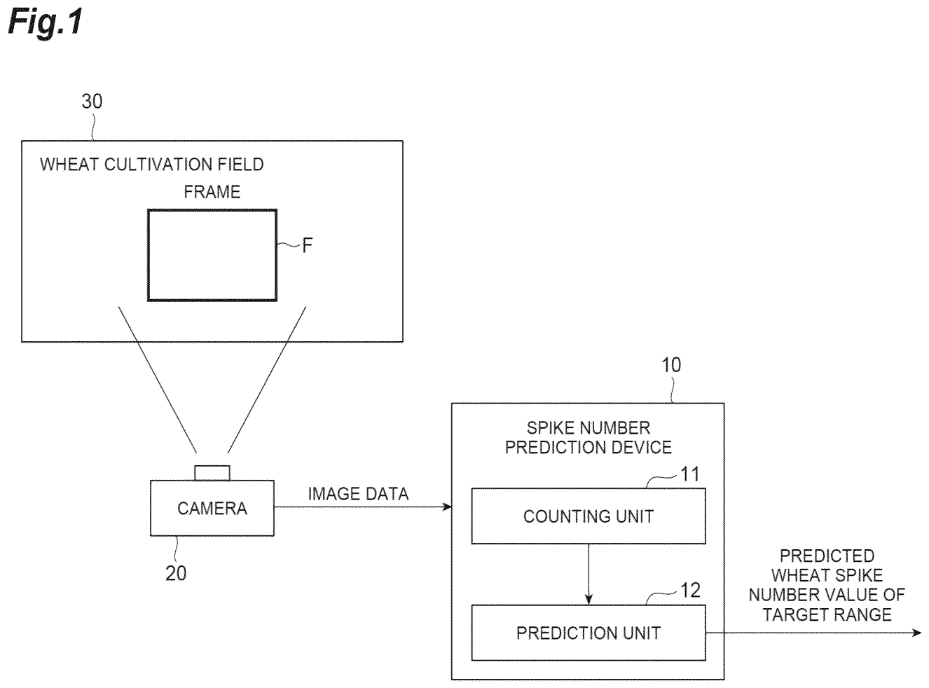

A spike number prediction device 10 according to an embodiment illustrated in FIG. 1 acquires image data of a region image in which a region including “a rectangular frame F provided in a wheat cultivation field 30” as an example of a frame-shaped body provided in a cultivation field of grain is reflected by a camera 20, and predicts the number of spikes (here, the number of wheat spikes) of grain in a target range (for example, the entire wheat cultivation field 30) from the image data.

The spike number prediction device 10 includes a counting unit 11 and a prediction unit 12 as functional blocks for implementing functions pertaining to the present disclosure. Of these, the counting unit 11 is a functional unit that counts the number of wheat spikes from image data reflected inside the frame F using an image recognition technique. The prediction unit 12 is a functional unit that predicts, based on a relative size relationship (area ratio) between a predetermined target range (for example, the entire wheat cultivation field 30) in the wheat cultivation field 30 and the frame F, and a wheat spike number count value obtained by counting, the number of wheat spikes in the target range.

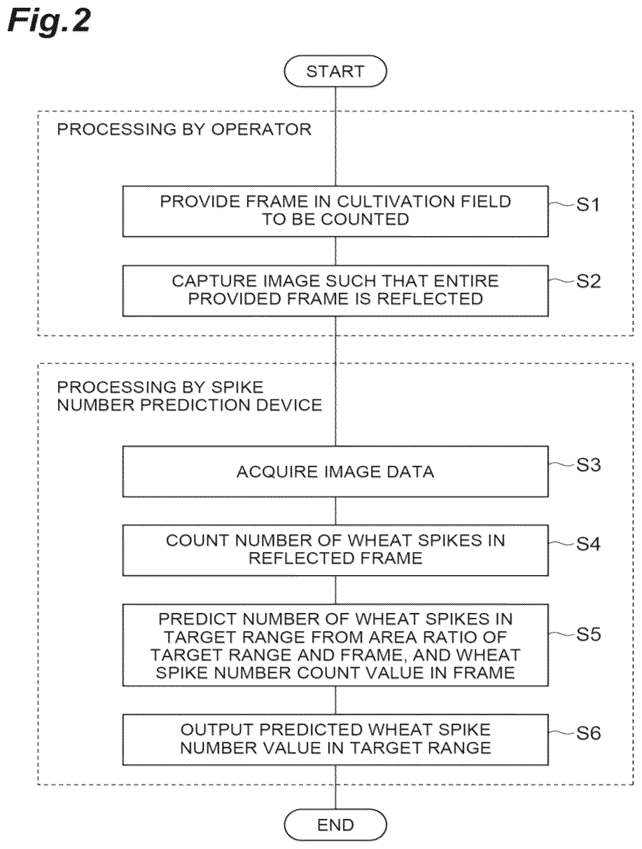

Next, processing pertaining to spike number prediction will be described along a flowchart of FIG. 2. As illustrated in FIG. 2, the processing includes processing (Steps S3 to S6) by the spike number prediction device 10 and processing (Steps S1 and S2) by an operator corresponding to preliminary preparation.

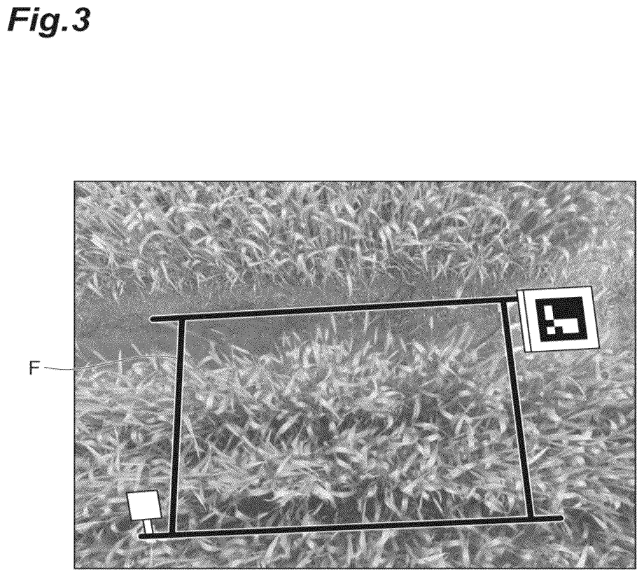

First, as the processing by the operator, as illustrated in FIG. 3, the operator provides a frame F in a cultivation field to be counted (Step S1), and captures an image with the camera 20 such that the entire provided frame is reflected (Step S2). With this, image data of a region image in which a region including the frame F is reflected, as illustrated in FIG. 3 is obtained.

Next, as the processing by the spike number prediction device 10, the counting unit 11 acquires the image data of the region image in which the region including the frame F described above is reflected (Step S3), and counts the number of wheat spikes in the frame F (Step S4). In Step S4, specifically, the counting unit 11 detects wheat spikes from image data reflected inside the frame F using an existing image recognition technique and counts the number of detected wheat spikes and to obtain a wheat spike number count value.

Then, the prediction unit 12 predicts, based on a relative size relationship between a predetermined target range (for example, the entire wheat cultivation field 30) and the frame F, and the wheat spike number count value, the number of wheat spikes in the target range (Step S5), and outputs a predicted wheat spike number value of the target range (Step S6). For example, the prediction unit 12 uses an area ratio (an area of the target range/an area of the frame F) as an example of the above-described relative size relationship to predict the number of wheat spikes in the target range by multiplying the wheat spike number count value and the above-described area ratio (the area of the target range/the area of the frame F) and outputs an obtained predicted wheat spike number value of the target range. The “output” herein includes outputs in various forms such as display output on a display, print output to a printer, and data transmission to an external device.

According to the embodiment described above, it is not necessary to strictly adjust a distance between the camera and the cultivation field and an angle of view of the camera with respect to the target range manually such that the target range and an imaging range by the camera match each other. For this reason, it is possible to reduce a processing load of time or labor required for such adjustment operation.

To designate the target range of spike number prediction, a method in which a frame-shaped body is provided at a desired position in a cultivation field of grain is used. With this, it is possible to freely designate the target range of spike number prediction, and to improve a degree of freedom of the spike number prediction processing of grain. This results in improvement of the prediction accuracy of the spike number prediction processing. For example, even if the density of spikes of grain in the cultivation field of grain varies, and an image in which the cultivation field is reflected has shading, the frame-shaped body is provided in an area having less shading in the image and is set as a target range of spike number prediction, so that it is possible to improve the accuracy of spike number prediction. In addition, with the use of the frame-shaped body, it is possible to image the cultivation filed such that noise does not enter the inside of the frame-shaped body, and to obtain image data. For example, even if noise (a finger of a person capturing an image, or the like) is reflected in an end portion of an imaging range during imaging, no problem occurs as long as noise does not enter the inside of the frame-shaped body, and it is possible to obtain proper image data.

In a case where the frame-shaped body is not used, it is not easy to obtain an area ratio or the like between the target range (for example, a prescribed area of the cultivation field) of spike number prediction and an imaging range obtained as image data, and the spike number prediction processing is not easy. As a result, as in the present disclosure, with the use of the real frame-shaped body, it is easy to obtain the area ratio or the like between the target range of spike number prediction and the frame-shaped body, and it is possible to easily predict the number of spikes in the target range.

In the embodiment described above, although an example where “the number of wheat spikes” is predicted as “the number of spikes of the grain” has been described, the technique of the present disclosure can also be applied to a case where the number of spikes of grain such as rice, millet, or barnyard millet other than wheat is predicted, and similar effects are obtained.

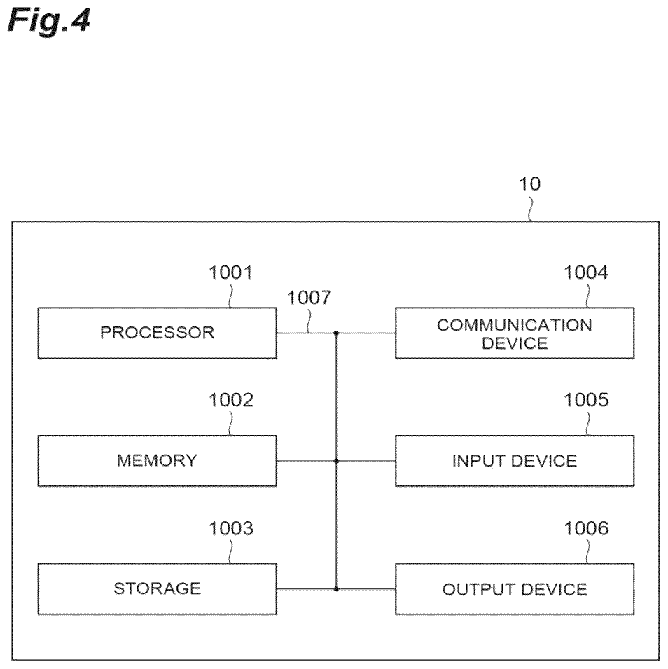

### Description of Terms, Description of Hardware Configuration (FIG. 4), and the Like

The block diagram used to describe the above-described embodiment and the modification examples illustrates blocks in units of functions. These functional blocks (constituent units) are implemented in any combination of at least one of hardware and software. Also, the implementation method of each functional block is not particularly limited. That is, each functional block may be implemented using one device combined physically or logically or may be implemented by directly or indirectly connecting two or more devices separated physically or logically (for example, in a wired or wireless manner) and using the plurality of devices. The functional blocks may be implemented by combining software with one device or the plurality of devices.

The functions include determining, deciding, judging, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like, but are not limited thereto. For example, a functional block (configuration unit) that causes transmitting is referred to as a transmitting unit or a transmitter. In any case, as described above, the implementation method is not particularly limited.

For example, the spike number prediction device in an embodiment of the present disclosure may function as a computer that executes processing in the present embodiment. FIG. 4 is a diagram illustrating a hardware configuration example of the spike number prediction device 10 according to the embodiment of the present disclosure. The above-described spike number prediction device 10 may be physically configured as a computer device including a processor 1001, a memory 1002, a storage 1003, a communication device 1004, an input device 1005, an output device 1006, a bus 1007, and the like.

In the following description, the term “device” can be replaced with a circuit, a device, a unit, or the like. The hardware configuration of the spike number prediction device 10 may be configured to include one or a plurality of devices among the devices illustrated in the drawing or may be configured without including part of the devices.

Each function in the spike number prediction device 10 is implemented by having the processor 1001 perform an arithmetic operation by reading prescribed software (program) on hardware such as the processor 1001 and the memory 1002, and control communication by the communication device 1004 or at least one of reading and writing of data in the memory 1002 and the storage 1003.

The processor 1001 operates, for example, an operating system to control the entire computer. The processor 1001 may be configured with a central processing unit (CPU) including an interface with peripheral devices, a control device, an arithmetic device, a register, and the like.

The processor 1001 reads a program (program code), a software module, data, and the like from at least one of the storage 1003 and the communication device 1004 to the memory 1002 and executes various kinds of processing according to the program, the software module, data, and the like. As the program, a program that causes the computer to execute at least a part of the operations described in the above-described embodiment is used. Although the description has been made that various kinds of processing described above are executed by one processor 1001, various kinds of processing may be executed simultaneously or sequentially by two or more processors 1001. The processor 1001 may be implemented by one or more chips. The program may be transmitted from the network via a telecommunication line.

The memory 1002 is a computer-readable recording medium, and may be configured with at least one of, for example, a read only memory (ROM), an erasable programmable ROM (EPROM), an electrically erasable programmable ROM (EEPROM), and a random access memory (RAM). The memory 1002 may be referred to as a register, a cache, a main memory (main storage device), or the like. The memory 1002 can store a program (program code), a software module, or the like that is executable to perform a wireless communication method according to an embodiment of the present invention.

The storage 1003 is a computer-readable recording medium, and may be configured with at least one of, for example, an optical disc such as a compact disc ROM (CD-ROM), a hard disk drive, a flexible disk, a magneto-optical disk (for example, a compact disk, a digital versatile disk, or a Blu-ray (Registered Trademark) disk), a smart card, a flash memory (for example, a card, a stick, or a key drive), a Floppy (Registered Trademark) disk, and a magnetic strip. The storage 1003 may be referred to as an auxiliary storage device. The above-described storage medium may be, for example, a database including at least one of the memory 1002 and the storage 1003 or other appropriate mediums.

The communication device 1004 is hardware (transmission and reception device) that is provided to perform communication between computers via at least one of a wired network and a wireless network, and is also referred to as, for example, a network device, a network controller, a network card, or a communication module.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs an output to the outside. The input device 1005 and the output device 1006 may be integrated (for example, a touch panel). The devices such as the processor 1001 and the memory 1002 are connected by the bus 1007 that is provided to communicate information. The bus 1007 may be configured using a single bus or may be configured using different buses between devices.

Each aspect/embodiment described in the present disclosure may be used alone, may be used in combination, or may be switched according to implementation. Furthermore, notification of predetermined information (for example, notification of “being X”) is not limited to explicit notification, but may be performed by implicit notification (for example, not performing notification of the predetermined information).

While the present disclosure has been described above in detail, it will be apparent to those skilled in the art that the present disclosure is not limited to the embodiments described in the present disclosure. The present disclosure may be implemented as modified and changed aspects without departing from the spirit and scope of the present disclosure defined by the description in the claims. Therefore, the description in the present disclosure is for illustration and does not have any restrictive meaning with respect to the present disclosure.

A process procedure, a sequence, a flowchart, and the like in each aspect/embodiment described in the present disclosure may be in a different order unless inconsistency arises. For example, for the method described in the present disclosure, elements of various steps are presented using an exemplary order, and the elements are not limited to the presented specific order.

Input or output information or the like may be stored in a specific place (for example, a memory) or may be managed using a management table. Information or the like to be input or output can be overwritten, updated, or additionally written. Output information or the like may be deleted. Input information or the like may be transmitted to another device.

The expression “based on” used in the present disclosure does not mean “based on only” unless otherwise described. In other words, the expression “based on” means both “based on only” and “based on at least”.

In the present disclosure, in a case where the terms “include”, “including”, and modifications thereof are used, these terms are intended to be comprehensive similarly to the term “comprising”. In addition, the term “or” used in the present disclosure is intended not to be an exclusive OR.

In the present disclosure, for example, in a case where an article such as “a”, “an”, or “the” in English is added through translation, the present disclosure may include a case where a noun following the article is of a plural form.

In the present disclosure, the term “A and B are different” may mean that “A and B are different from each other”. This term may mean that “each of A and B is different from C”. Terms “separate” and “coupled” may also be interpreted in a similar manner to “different”.

### REFERENCE SIGNS LIST

10: Spike number prediction device, 11: Counting unit, 12: Prediction unit, 20: Camera, 30: Wheat cultivation field, 1001: Processor, 1002: Memory, 1003: Storage, 1004: Communication device, 1005: Input device, 1006: Output device, 1007: Bus.

1. A spike number prediction device comprising:
a counting unit configured to count the number of spikes of grain from image data of the grain reflected inside a frame-shaped body provided in a cultivation field of the grain using an image recognition technique; and
a prediction unit configured to predict, based on a relative size relationship between a predetermined target range in the cultivation field and the frame-shaped body, and a spike number count value obtained by counting in the counting unit, the number of spikes of the grain in the target range.

2. The spike number prediction device according to claim 1, wherein the prediction unit is configured to
predict the number of spikes of the grain in the target range from an area ratio between the target range and the frame-shaped body as the relative size relationship, and the spike number count value.
